(19) United States
(12) Patent Application Publication
(10) Pub. No.: US 2026/0326018 A1
(43) Pub. Date: Oct. 22, 2026

(54) ADSORPTION AND DESORPTION ASSEMBLY WITH SEALING DOORS

(71) Applicant: Mosaic Materials, Inc., Alameda, CA (US)

(72) Inventors: Steven Craig Russell, The Woodlands, TX (US); Paul Cody, Houston, TX (US); Dustin Kraft, Houston, TX (US); Samuel H. Cheng, Katy, TX (US); Jared Blanton, Oakland, CA (US)

(21) Appl. No.: 19/181,870

(22) Filed: Apr. 17, 2025

(51) Int. Cl. B01D 53/04

(52) U.S. Cl. CPC B01D 53/0446; B01D 53/0438; B01D 2257/504; B01D 2259/40098

(57) ABSTRACT

An adsorption and desorption assembly includes a housing defining a plenum space therein, an inlet assembly including an inlet frame including a first inlet opening and a second inlet opening, the first inlet opening and the second inlet opening being fluidly connected to the plenum space, a first sorbent module disposed within the first inlet opening and a second sorbent module disposed within the second inlet opening, the first sorbent module configured to adsorb gas(es), vapor(s), or a mixture thereof from fluid passing through the first inlet opening, and the second sorbent module configured to adsorb the gas(es), the vapor(s), or the mixture thereof from fluid passing through the second inlet opening, and a desorption structure movable between the first inlet opening and the second inlet opening, and one or more flow generators fluidly connected to the plenum space.

### BACKGROUND

Various manufacturing and chemical systems may release fluid that include gas(es), vapor(s), or a mixture thereof. Adsorption systems may use sorbents to remove from the gas(es), the vapor(s), or the mixture thereof form the fluid via adsorption. For example, adsorption systems such as carbon capture systems may capture carbon dioxide from a gas stream via adsorption with sorbent(s). Desorption systems may then separate the gas(es), the vapor(s), or the mixture thereof from the sorbent(s) for storage, and the sorbent(s) may be reused. Improvement(s) in the adsorption and desorption systems may be desirable.

### SUMMARY

An embodiment of an adsorption and desorption assembly includes a housing defining a plenum space therein, an inlet assembly, including an inlet frame comprising a first inlet opening and a second inlet opening, the first inlet opening and the second inlet opening being fluidly connected to the plenum space, a first sorbent module disposed within the first inlet opening and a second sorbent module disposed within the second inlet opening, the first sorbent module configured to adsorb gas(es), vapor(s), or a mixture thereof from fluid passing through the first inlet opening, and the second sorbent module configured to adsorb the gas(es), the vapor(s), or the mixture thereof from fluid passing through the second inlet opening, and a desorption structure movable between the first inlet opening and the second inlet opening, and one or more flow generators fluidly connected to the plenum space and configured to remove, from the plenum space, fluid with the gas(es), the vapor(s), or the mixture thereof adsorbed therefrom by the first sorbent module or the second sorbent module, wherein the desorption structure is configured to form a sealed enclosure around the first sorbent module and desorb the gas(es), the vapor(s), or the mixture thereof from the first sorbent module when the desorption structure is positioned at the first inlet opening, and the desorption structure is configured to form the sealed enclosure around the second sorbent module and desorb the gas(es), the vapor(s), or the mixture thereof from the second sorbent module when the desorption structure is positioned at the second inlet opening.

An embodiment of a method includes generating a first flow of fluid through a first sorbent module disposed at a first inlet opening of an adsorption and desorption assembly into a plenum space within the adsorption and desorption assembly to adsorb gas(es), vapor(s), or a mixture thereof from the first flow of fluid, positioning a desorption structure at a second inlet opening of the adsorption and desorption assembly, forming a sealed enclosure around a second sorbent module disposed at a second inlet opening of the adsorption and desorption assembly via a desorption structure and desorbing the gas(es), the vapor(s), or the mixture thereof from the second sorbent module, moving the desorption structure from the second inlet opening to the first inlet opening of the adsorption and desorption assembly, generating a second flow of fluid through the second sorbent module disposed at the second inlet opening into the plenum space to adsorb the gas(es), the vapor(s), or the mixture thereof from the second flow of fluid, and forming the sealed enclosure around the first sorbent module via the desorption structure and desorbing the gas(es), the vapor(s), or the mixture thereof from the second first module, wherein the generating the first flow of fluid through the first sorbent module and the desorbing the gas(es), the vapor(s), or the mixture thereof from the second sorbent module are performed simultaneously, and the generating the second flow of fluid through the second sorbent module and the desorbing the gas(es), the vapor(s), or the mixture thereof from the first sorbent module are performed simultaneously.

An embodiment of an adsorption and desorption assembly includes a housing defining a plenum space therein, an inlet assembly, including an inlet frame comprising a first inlet opening and a second inlet opening, the first inlet opening and the second inlet opening being fluidly connected to the plenum space, a first sorbent module disposed within the first inlet opening and a second sorbent module disposed within the second inlet opening, the first sorbent module configured to adsorb gas(es), vapor(s), or a mixture thereof from fluid passing through the first inlet opening, and the second sorbent module configured to adsorb the gas(es), the vapor(s), or the mixture thereof from fluid passing through the second inlet opening, and one or more sealing structures, one or more desorption structures, and one or more flow generators fluidly connected to the plenum space and configured to remove, from the plenum space, fluid with the gas(es), the vapor(s), or the mixture thereof adsorbed therefrom by the first sorbent module or the second sorbent module, wherein the one or more sealing structures is configured to form a sealed enclosure around the first sorbent module and the one or more desorption structures is configured to desorb the gas(es), the vapor(s), or the mixture thereof from the first sorbent module within the sealed enclosure, and the one or more sealing structures is configured to form the sealed enclosure around the second sorbent module and desorb the gas(es), the vapor(s), or the mixture thereof from the second sorbent module within the sealed enclosure.

### BRIEF DESCRIPTION OF THE DRAWINGS

The following descriptions should not be considered limiting in any way. With reference to the accompanying drawings, like elements are numbered alike:

FIG. 1 is a schematic diagram showing an adsorption and desorption system with an adsorption and desorption assembly according to one or more embodiments;

FIG. 2 is a perspective view of an adsorption and desorption assembly according to one or more embodiments;

FIGS. 3A, 3B, and 3C are schematic diagram showing an upstream sealing door in different positions of an adsorption and desorption assembly according to one or more embodiments;

FIG. 4 is a perspective view of an inlet assembly according to one or more embodiments;

FIG. 5 is a perspective cross-sectional view of an adsorption and desorption assembly according to one or more embodiments;

FIG. 6 is a perspective view of a sealing door with a heater according to one or more embodiments;

FIG. 7A is a perspective view of an inlet assembly with a preliminary heater aligned with a sealing door according to one or more embodiments;

FIG. 7B is a perspective view of an inlet assembly with a preliminary heater aligned with an adsorption inlet according to one or more embodiments;

FIG. 8 shows components of an adsorption and desorption assembly according to one or more embodiments;

FIG. 9 shows a cross-sectional view of a desorption structure taken at 9-9 in FIG. 4;

FIG. 10 shows a perspective cross-sectional view of an adsorption and desorption assembly according to one or more embodiments;

FIG. 11A is a perspective view of an adsorption and desorption assembly according to one or more embodiments;

FIG. 11B is a perspective cross-sectional view of the adsorption and desorption assembly of FIG. 11A;

FIG. 12 shows a cross-sectional view of a desorption structure of FIG. 11A;

FIG. 13A is a perspective view of an adsorption and desorption assembly according to one or more embodiments;

FIG. 13B is a perspective cross-sectional view of the adsorption and desorption assembly of FIG. 13A;

FIG. 14 shows a cross-sectional view of a desorption structure of FIG. 13A;

FIG. 15A is a perspective view of an adsorption and desorption assembly according to one or more embodiments;

FIG. 15B is a perspective cross-sectional view of the adsorption and desorption assembly of FIG. 14A; AND

FIG. 16 shows a cross-sectional view of a desorption structure of FIG. 15A.

### DETAILED DESCRIPTION

A detailed description of one or more embodiments of the disclosed apparatus and method are presented herein by way of exemplification and not limitation with reference to the Figures.

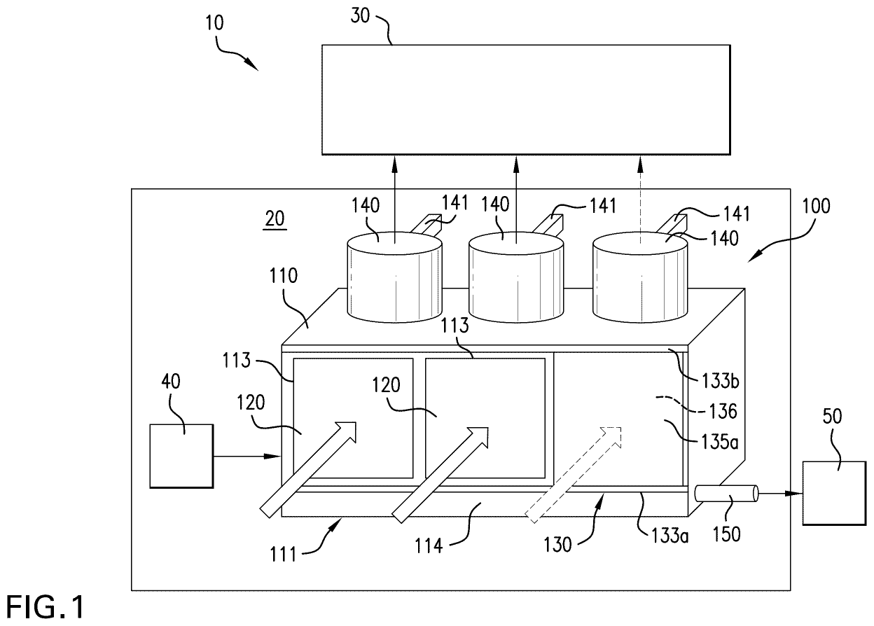

FIG. 1 shows an adsorption and desorption system 10. As a non-limiting example, the dynamic adsorption and desorption system 10 may be part of a carbon capture system. As a non-limiting example, the dynamic adsorption and desorption system 10 may be part of a direct carbon capture system. The adsorption and desorption system 10 includes an area 20 in which an adsorption and desorption assembly 100 is positioned. The area 20 may be an enclosure, e.g., an enclosed room. Alternatively, the area 20 may be open to the outside environment.

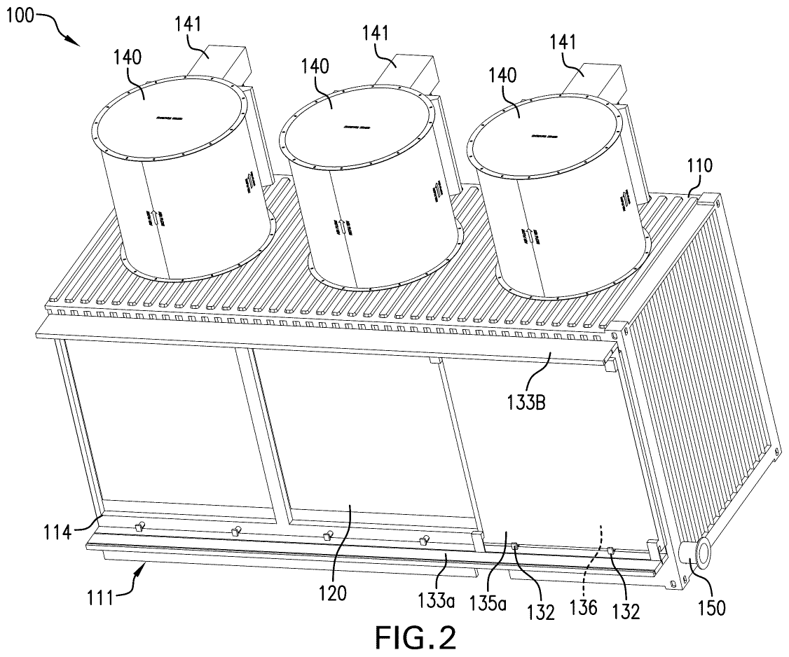

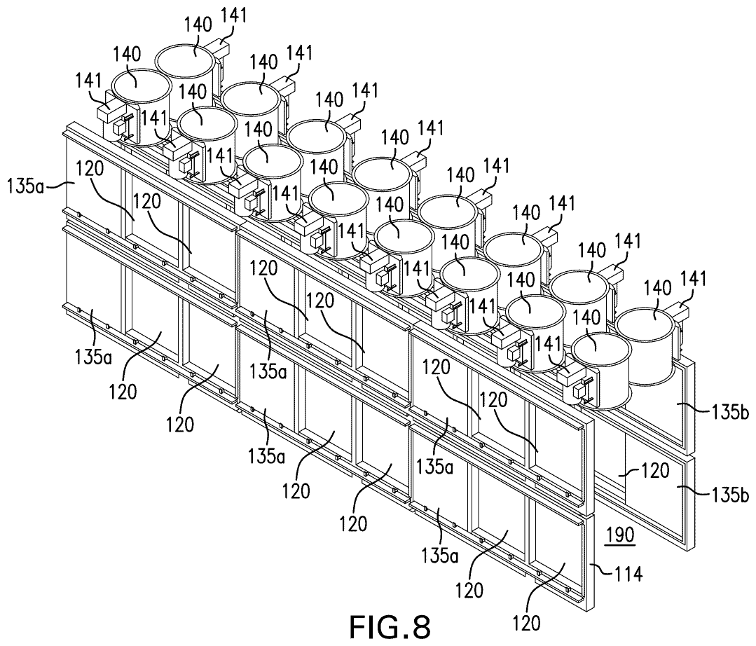

FIG. 2 shows a non-limiting example of the adsorption and desorption assembly 100. The adsorption and desorption assembly 100 includes a housing 110 and an inlet assembly 111 mounted on the housing 110. Each of the one or more inlet assemblies 111 may be structured as at least a portion of a side wall of the housing 110. As shown in FIG. 1, a single inlet assembly 111 may be disposed on the housing 110 or, as shown in FIG. 8, a plurality of inlet assemblies 111 may be disposed on the housing 110. As a non-limiting example, an inlet assembly 111 may be disposed on opposite sides of the housing 110. The inlet assembly 111 includes an inlet frame 114 mounted on the housing 110. The inlet frame 114 defines a plurality of inlet openings 113. Sorbent modules 120 are disposed within the inlet openings 113. The sorbent modules 120 may be self-supporting on the inlet frame 114 by forming sorbent into a shape corresponding to the inlet openings 113 or may be loose sorbent, e.g., pellets of sorbent, disposed within a porous frame. The sorbent modules 120 may be contactor assemblies, sorbent beds, and/or sorbent filters. According to one or more embodiments, sorbent within the sorbent modules 120 may be solid sorbent (e.g. metal-organic framework materials, zeolites, mesoporous silicas, amine-functionalized solid sorbents, etc.).

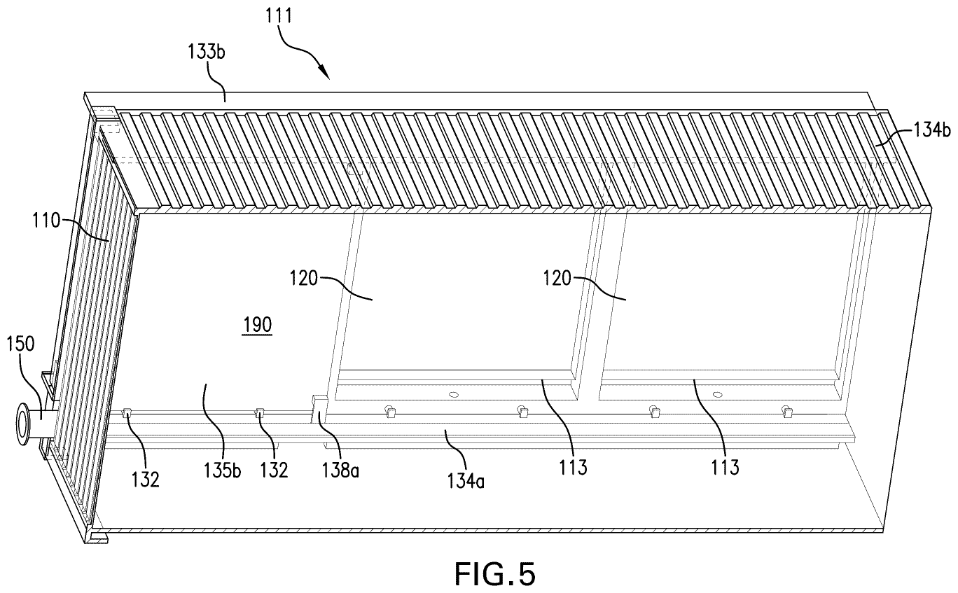

The housing 110 may define a plenum space 190 therein (See FIGS. 5, 8, and 9). The sorbent modules 120 may cover entireties of the inlet openings 113 such that the fluid must pass through the sorbent modules 120 to enter the plenum space 190. The inlet openings 113 of a single inlet assembly 111 may share the plenum space 190 or, alternatively, as shown in FIG. 8, an array of inlet assemblies 111 may be arranged on the housing 110 and enclose a shared plenum space 190. The plenum space 190 may be an undivided space that is fluidly connected to each of the inlet openings 113. The adsorption and desorption assembly 100 may include a plurality of flow generators 140 positioned on one of the surfaces of the housing 110. The flow generators 140 are fluidly coupled to the plenum space 190 defined within the housing 110. Although the drawings show a plurality of flow generators 140, the adsorption and desorption assembly 100 may instead include a single shared flow generator 140. The flow generators may be, for example, fans, blowers, pumps, or other flow generation structures known in the art. The flow generators may be driven by motors 141. Outlets of the flow generators 140 may be coupled to a lean gas destination 30. The lean gas destination 30 may be, for example, a tank or the atmosphere. The flow generators 140 may exhaust the lean gas directly to the area 20 outside of the adsorption and desorption assembly 100.

The flow generators may generate flow of fluid from the area 20 through the sorbent modules 120 in the inlet openings 113 into the plenum space 190 within the housing 110, and the sorbent modules 120 adsorbs gas(es), vapor(s), or a mixture thereof from the fluid passing therethrough such that lean fluid flows into the plenum space 190. The lean fluid then flows out of the plenum space 190 in the housing 110 through an outlet of the flow generator 140 to the lean gas destination 30. Thus, adsorption is performed on the fluid within the area 20. Examples of gas(es), vapor(s), or a mixture thereof adsorbed by the sorbent and removed by the adsorption and desorption system 10 may include, but are not limited to, CO₂, H₂O, H₂, O₂, N₂, CO, NH₃, C₂H₄, C₂H₆, C₃H₆, C₃H, H₂S, SO₂, and NO₂.

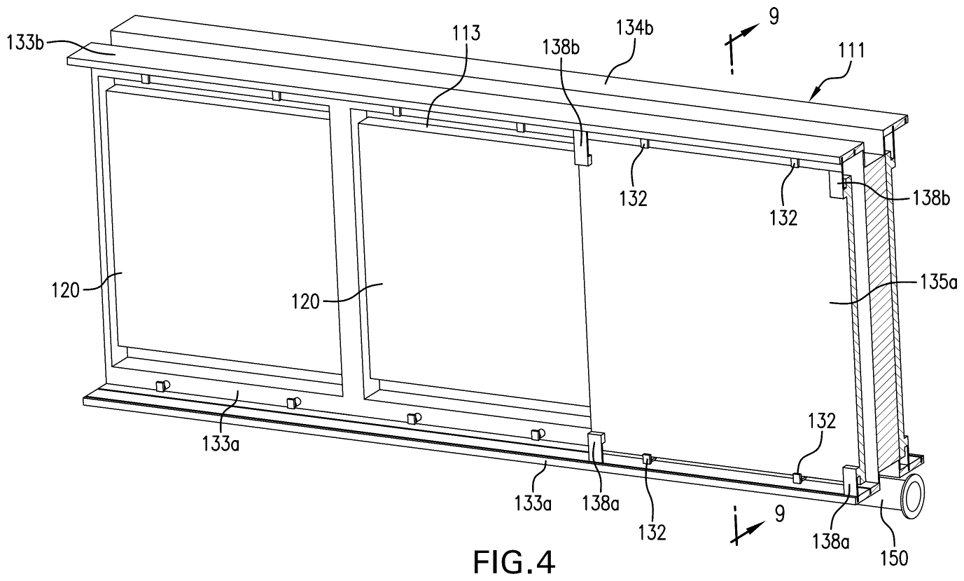

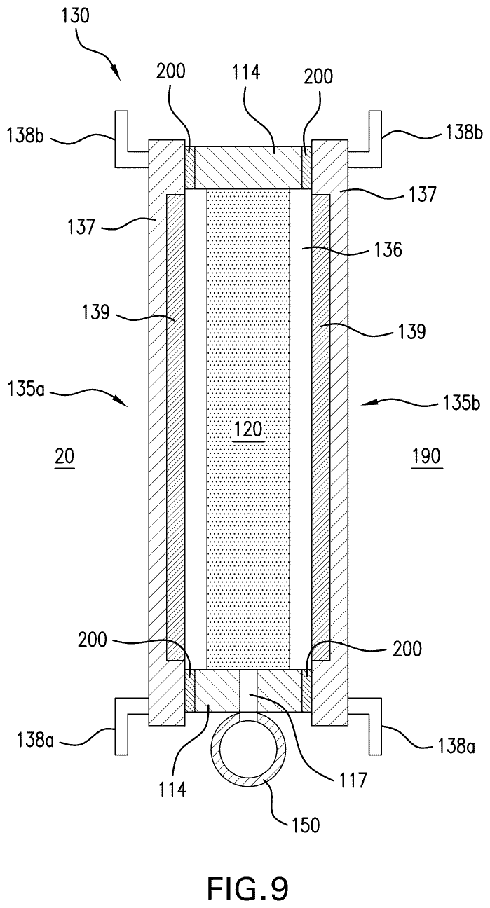

As shown in FIGS. 4 and 5, the inlet assembly 111 may include a desorption structure 130. As adsorption is performed by the sorbent modules 120 and the sorbent modules 120 adsorb the gas(es), the vapor(s), or the mixture thereof, the sorbent modules 120 may become more saturated which reduces adsorption efficiency over time. The desorption structure 130 may desorb the gas(es), the vapor(s), or the mixture thereof from the sorbent modules 120. The desorption structure 130 includes an upstream sealing door 135a and a downstream sealing door 135b that are positioned on opposite sides of one of the inlet openings 113. The upstream sealing door 135a and downstream sealing door 135b may include sealing structures 200 (see FIG. 9) that seal against portions of the inlet frame 114 surrounding the inlet opening 113. The sealing structures 200 may be annular, perimeter, or face sealing structures. The inlet assembly 111 may include actuators 132 that move the upstream sealing door 135a and downstream sealing door 135b toward and away from the inlet opening 113 to engage and release the sealing structures 200. Alternatively or additionally, the sealing structures 200 may be inflatable seals that may inflate to form the seal and deflate to release the seal. Thus, as shown in FIG. 9, the upstream sealing door 135a and downstream sealing door 135b may form a sealed enclosure 136 at the inlet opening 113, with the sorbent module 120 positioned within the sealed enclosure 136. The sealed enclosure 136 may be fluidly isolated from the area 20 and the plenum space 190.

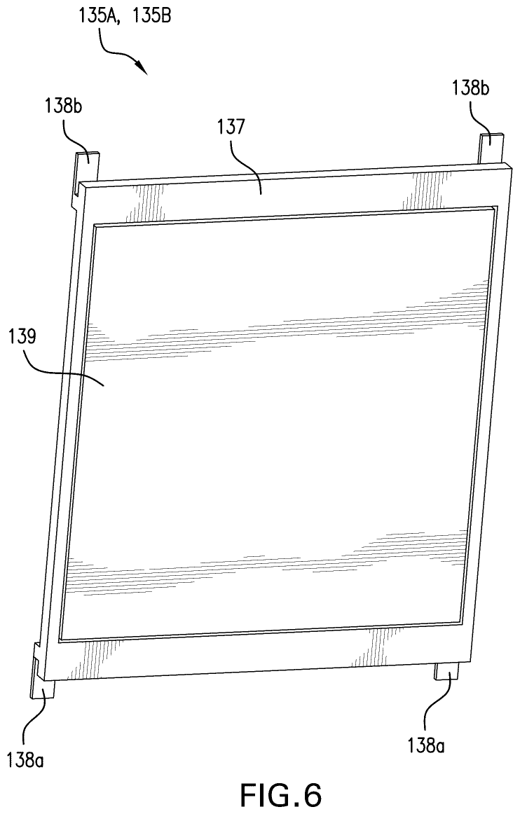

As shown in FIGS. 6 and 9, the upstream sealing door 135a and the downstream sealing door 135b may include a frame 137 in which a heater 139 is disposed. Additionally, the upstream sealing door 135a and the downstream sealing door 135b may include first rail tabs 138a and second rail tabs 138b extending from the frame 137. The heater 139 may be, for example, dielectric plates for a dielectric heater in which electromagnetic fields of the heaters 139 of the upstream sealing door 135a and the downstream sealing door 135b are alternated to heat the sorbent modules 120 within the sealed enclosure 136. Alternatively, the heater 139 may include coils of an inductive heater that heat the sorbent modules 120 within the sealed enclosure 136. The heater 139 may be a microwave heater. The heater 139 may also include other heaters known in the art. The desorption structure 130 may include electrical connectors that provide electrical power to the heater 139 and/or waveguides that provide microwave energy to the heater 139. As non-limiting examples, the electrical connector may be in the form of electrified rails or festooned electrical cables. Referring to FIG. 1, the adsorption and desorption assembly 100 includes a current generator 40 that is electrically coupled to the heater 139. The current generator 40 may be a dielectric generator or an induction generator. The heater 139 of the upstream sealing door 135a and the heater 139 of the downstream sealing door 135b may heat the sorbent module 120 within the sealed enclosure 136 which releases the gas(es), the vapor(s), or the mixture thereof from the sorbent module 120. The sealed enclosure 136 may be fluidly coupled to an outlet 150 via a flowpath 117 defined within the inlet frame 114, and as shown in FIG. 1, the outlet 150 may be coupled to a component destination 50. The component destination 50 may be, for example, a tank. The gas(es), the vapor(s), or the mixture thereof released from the sorbent module 120 via heat generated by the heaters 139 may exit the sealed enclosure 136 via the flowpath 117 and the outlet 150 to the component destination 50. The flowpath 117 may include a valve that is controlled to close and open. The sorbent module 120 may be desorbed by the desorption structure 130 and be subsequently used for adsorption. A vacuum manifold may be coupled to the sealed enclosure 136 to vacuum fluids within the sealed enclosure 136 prior to, during, and/or after the desorption process. Alternatively, the upstream sealing door 135a and/or the downstream sealing door 135b may have vacuum ports and connected to a flexible vacuum line.

The inlet assembly 111 may include a first upstream rail 133a, a second upstream rail 133b, a first downstream rail 134a, and a second downstream rail 134b formed on the inlet frame 114. Each of the first upstream rail 133a, the second upstream rail 133b, the first downstream rail 134a, and the second downstream rail 134b may extend across all of the inlet openings 113 of the inlet frame 114. The first rail tabs 138a of the upstream sealing door 135a may engage with the first upstream rail 133a, and the second rail tabs 138b of the upstream sealing door 135a may engage with the second upstream rail 133b. Further, the first rail tabs 138a of the downstream sealing door 135b may engage with the first downstream rail 134a and the second rail tabs 138b of the downstream sealing door 135b may engage with the second downstream rail 134b. Thus, the upstream sealing door 135a is slidable on the first upstream rail 133a and the second upstream rail 133b, and the downstream sealing door 135b is slidable on the first downstream rail 134a and the second downstream rail 134b. That is, the upstream sealing door 135a and the downstream sealing door 135b are movable between different inlet openings 113 of the inlet assembly 111. The upstream sealing door 135a and the downstream sealing door 135b may be movable together.

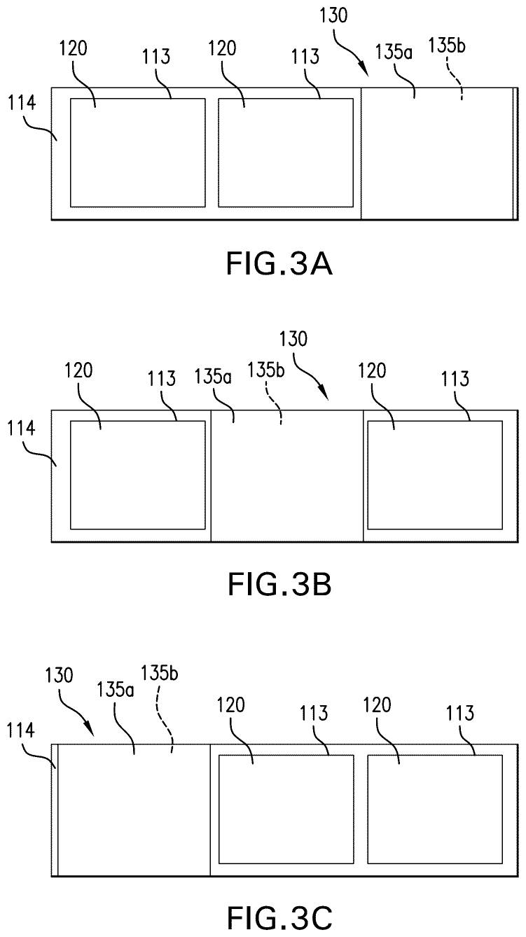

As shown in FIGS. 1 and 3A, the upstream sealing door 135a and the downstream sealing door 135b may be positioned to seal one of the sorbent modules 120 to perform desorption thereon while adsorption is performed via the sorbent modules 120 that are not blocked by the desorption structure 130. After the gas(es), the vapor(s), or the mixture thereof has been sufficiently desorbed from the sorbent module 120 within the sealed enclosure 136, the upstream sealing door 135a and the downstream sealing door 135b may then be moved (e.g., to the position shown in FIG. 3B or FIG. 3C) to seal another of the sorbent modules 120 to perform desorption thereon. Simultaneously, adsorption is performed via the sorbent modules 120 that are not blocked by the desorption structure 130. The desorption structure 130 may be cycled between the sorbent modules 120 such that adsorption and desorption may be simultaneously and continuously performed via the sorbent modules 120. Accordingly, the adsorption and desorption system 10 may simultaneously, continuously, and/or effectively perform adsorption and desorption, reducing downtime with a relatively simple arrangement.

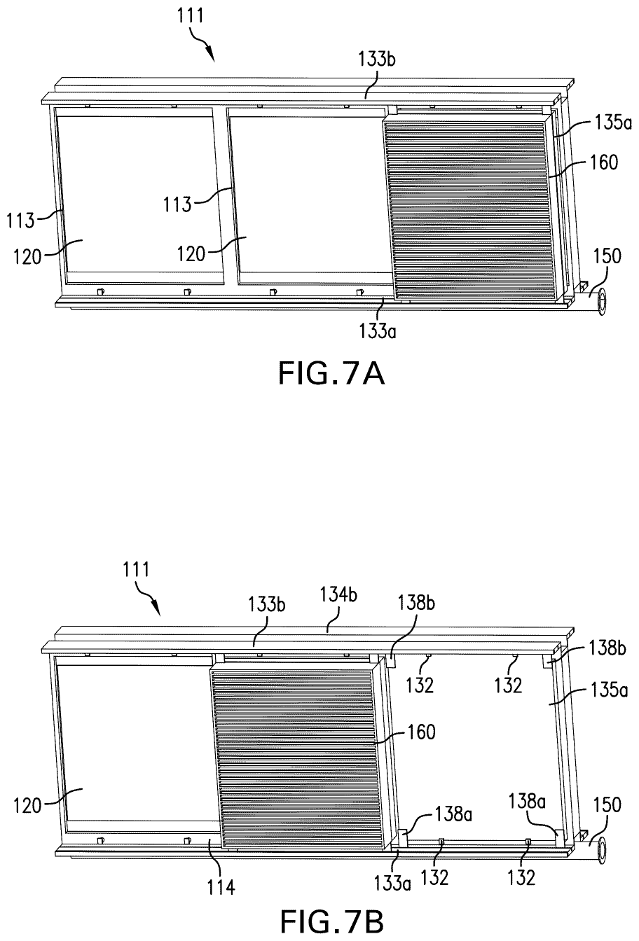

As shown in FIGS. 7A and 7B, the inlet assembly 111 may further include a preliminary heater 160 mounted on an upstream side of the inlet frame 114. The preliminary heater 160 may be, for example, an electrically resistive heater, a plate-fin heat exchanger with steam or any process fluid that exchanges heat with air, or other heaters known in the art. The preliminary heater 160 may be mounted to a track upstream of the upstream sealing door 135a and may be positioned adjacent to the upstream sealing door 135a when not in use and may be positioned adjacent to the sorbent modules 120 when in use. Thus, the preliminary heater 160 may be used in to heat and dry the fluid flowing through the sorbent modules 120 to increase adsorption efficiency by performing partial desorption of water at a low temperature than that of a subsequent main desorption process.

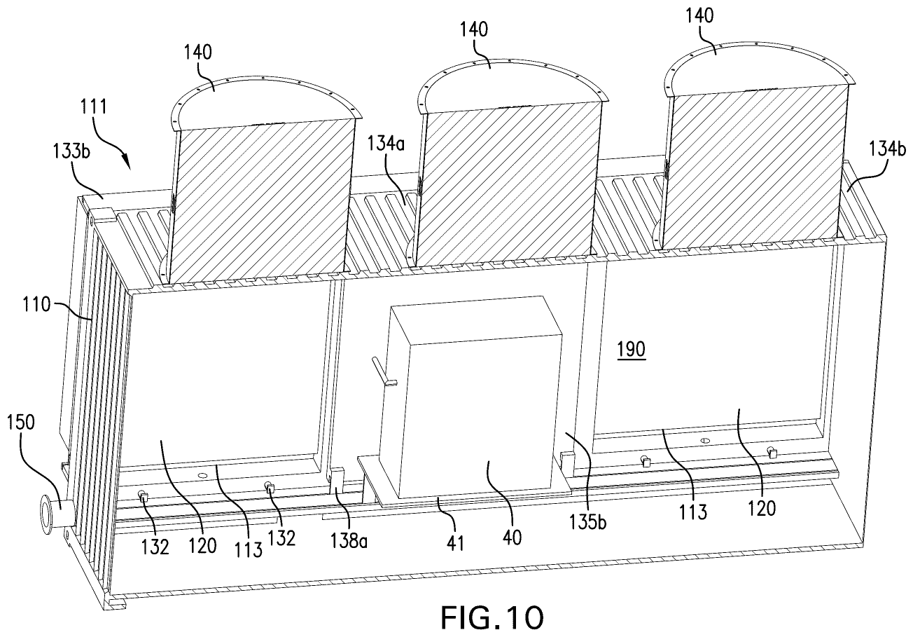

While FIG. 1 shows the current generator 40 outside of the housing 110, the current generator 40 may alternatively or additionally be disposed within the housing 110. For example, as shown in FIG. 10, the current generator 40 may be mounted on and/or adjacent to an inner surface of the downstream sealing door 135b. The current generator 40 may be supported on a slidable platform 41. The current generator 40 may be movable with the downstream sliding door 135b, for example, via the slidable platform 41, so as to not interfere with flow through the sorbent modules 120.

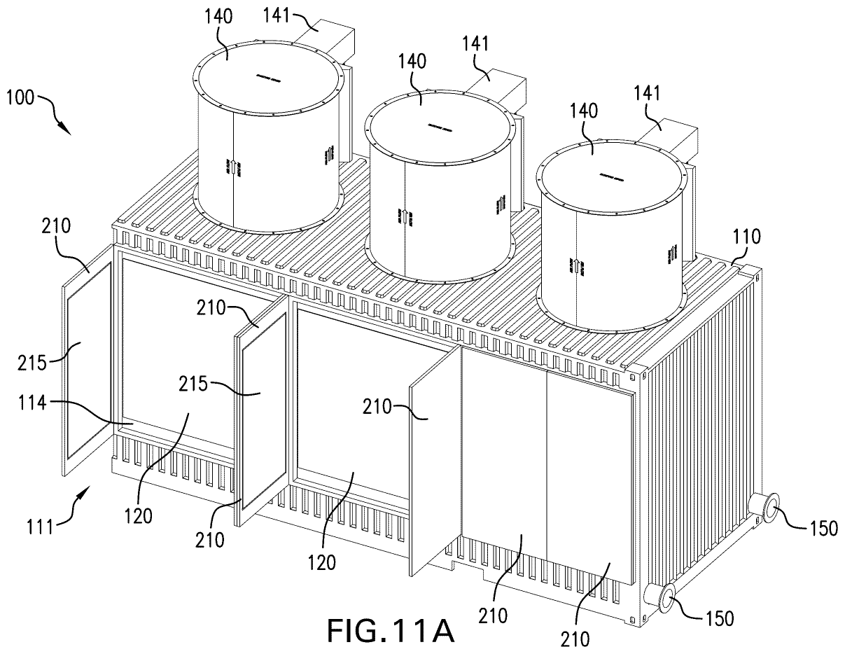

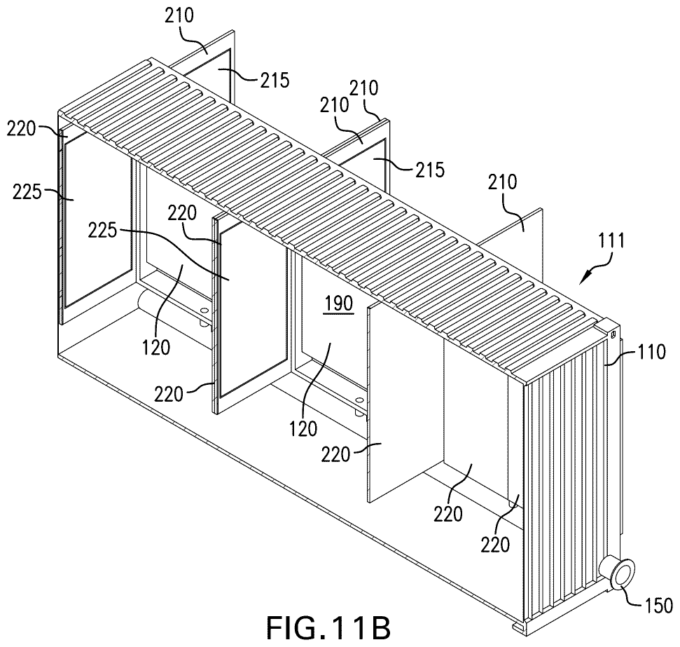

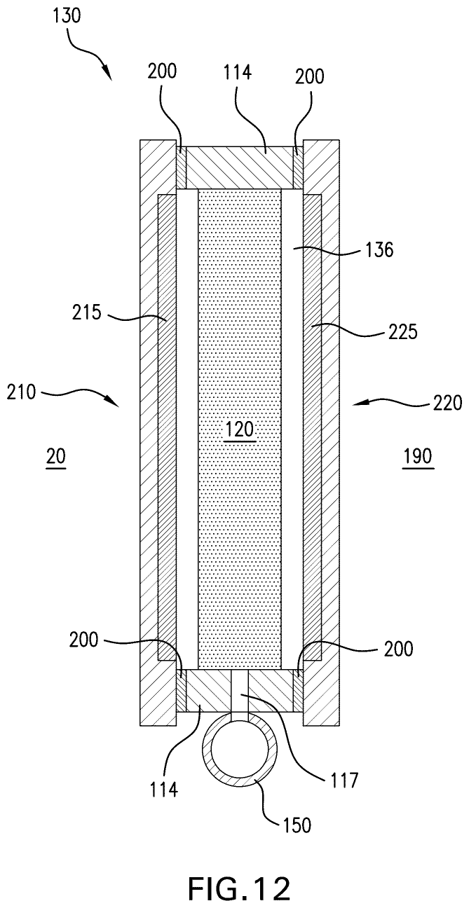

FIGS. 11A and 11B show a non-limiting example of the adsorption and desorption assembly 100, and FIG. 12 shows a desorption structure 130 of the adsorption and desorption assembly 100. The adsorption and desorption assembly 100 of FIGS. 11A and 11B is similar to that shown in FIGS. 1-10. However, instead of the upstream sealing door 135a and the downstream sealing door 135b, the adsorption and desorption assembly 100 of FIGS. 11A and 11B includes upstream sealing doors 210 and downstream sealing doors 220 that are hinged on the housing 110 and that are positioned at each of the inlet openings 113 of the housing 110. Each of the upstream sealing doors 210 includes a heater 215 mounted on a surface thereof facing the sorbent module 120, and each of the downstream sealing doors 220 includes a heater 225 mounted on a surface thereof facing the sorbent module 120. The upstream sealing doors 210 and the downstream sealing doors 220 may be closed to form a sealed enclosure therebetween having the sorbent module 120 therein to perform desorption on the sorbent module 120. The heaters 215, 225 may be similar in structure to the heaters 139 shown in FIGS. 6 and 9.

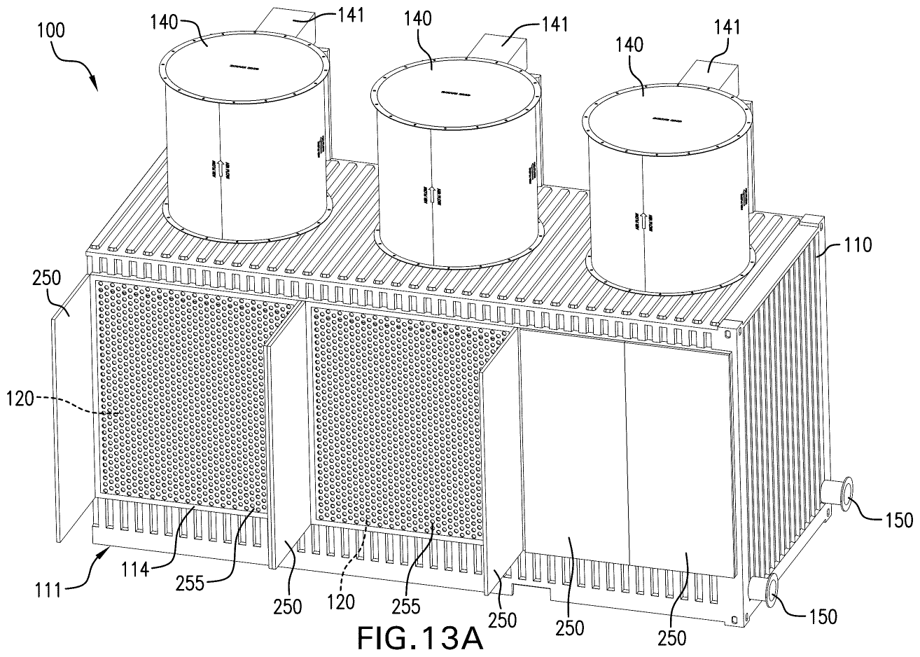

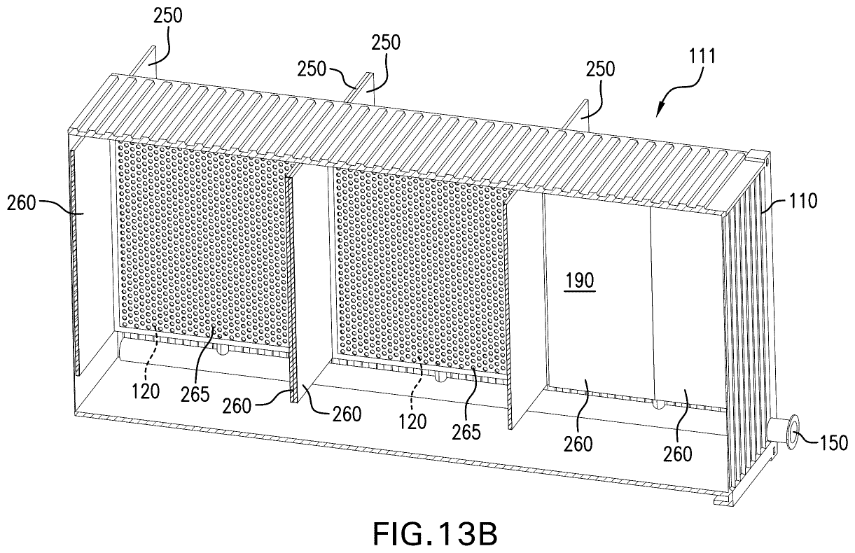

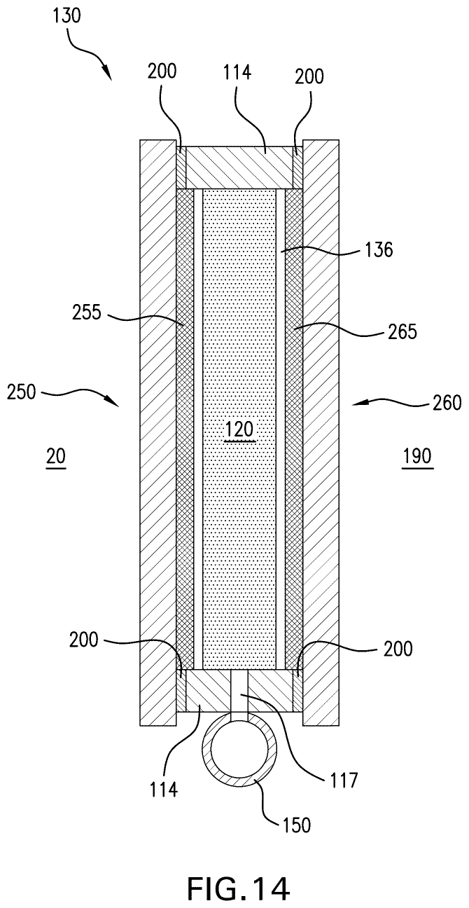

FIGS. 13A and 13B show a non-limiting example of the adsorption and desorption assembly 100, and FIG. 14 shows a desorption structure 130 of the adsorption and desorption assembly 100. The adsorption and desorption assembly 100 of FIGS. 13A and 13B is similar to that shown in FIGS. 11A and 11B. However, instead of the upstream and downstream sealing doors 210, 220 that have heaters 215, 225 mounted thereon, the adsorption and desorption assembly 100 of FIGS. 13A and 13B includes upstream sealing doors 250 and downstream sealing doors 260 do not have heaters mounted thereon. The upstream sealing doors 250 and the downstream sealing doors 260 are hinged on the housing 110 and are positioned at each of the inlet openings 113 of the housing 110. A porous upstream heater 255 may be fixed to each of the inlet openings 113 at an upstream side of the sorbent module 120, and a porous downstream heater 265 may be fixed to each of the inlet openings 113 at a downstream side of the sorbent module 120. The upstream sealing doors 250 and the downstream sealing doors 260 may be closed to form a sealed enclosure therebetween having the sorbent module 120 therein to perform desorption on the sorbent module 120 via the porous upstream heater 255 and the porous downstream heater 265. For inlet openings 113 where the upstream sealing doors 250 and the downstream sealing doors 260 are open, the flow generators 140 may induce flow of fluid therethrough and, due to the porous upstream heater 255 and the porous downstream heater 265 being porous, the fluid is able to flow through the porous upstream heater 255, the sorbent modules 120, and the porous downstream heater 265 such that the sorbent modules 120 perform adsorption on the fluid flowing therethrough.

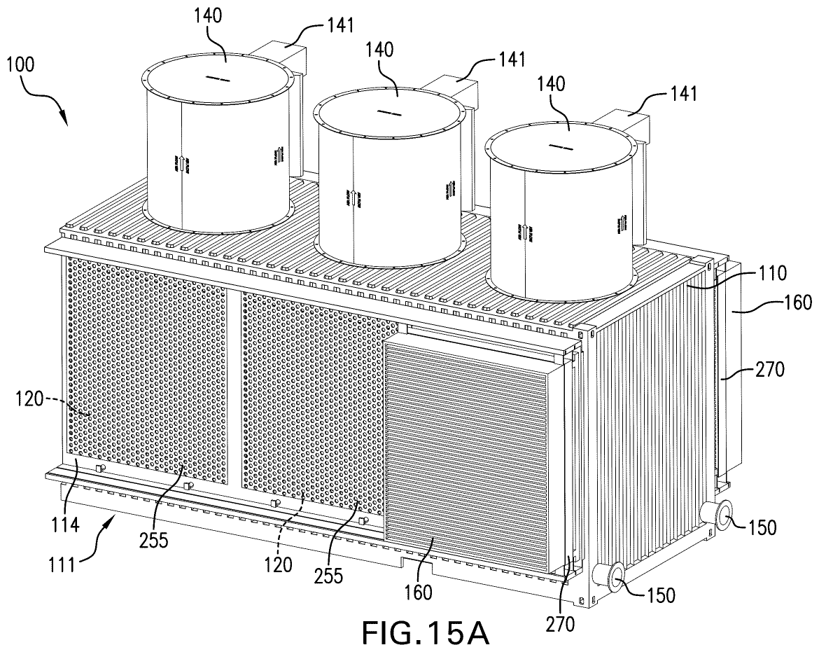

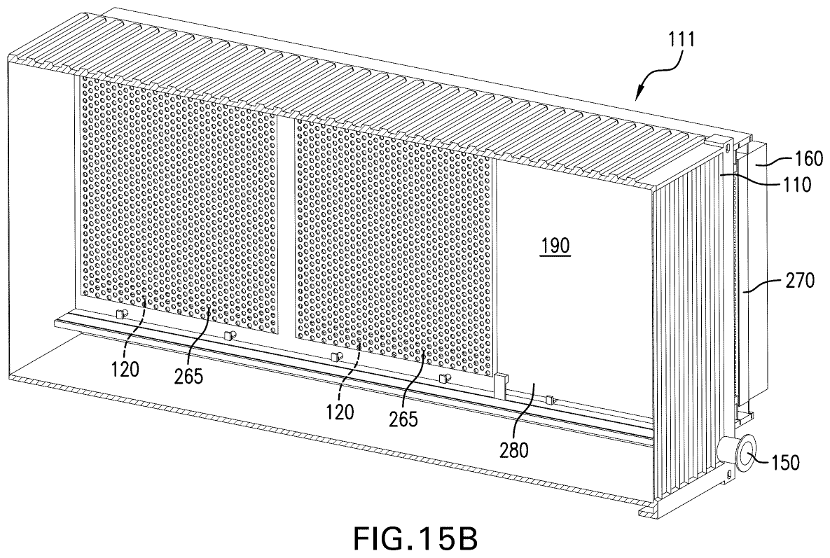

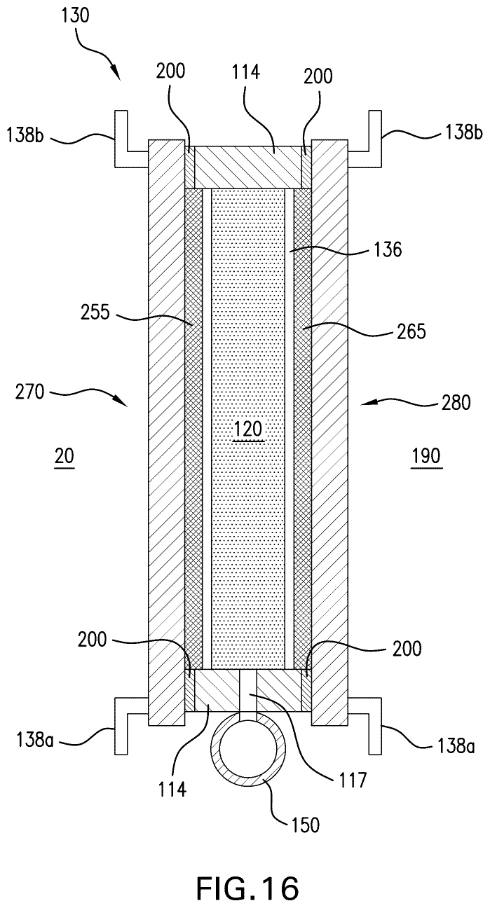

FIGS. 15A and 15B show a non-limiting example of the adsorption and desorption assembly 100, and FIG. 16 shows a desorption structure 130 of the adsorption and desorption assembly 100. The adsorption and desorption assembly 100 of FIGS. 15A and 15B is similar to that shown in FIGS. 13A and 13B. However, instead of the upstream and downstream sealing doors 250, 260 that are hinged on the housing 110, the adsorption and desorption assembly 100 of FIGS. 15A and 15B includes an upstream sealing door 270 and a downstream sealing door 280. The upstream sealing door 270 and the downstream sealing door 280 are similar to the upstream sealing door 135a and the downstream sealing door 135b shown in FIGS. 1-10, although the heaters 139 may be omitted. The upstream sealing door 270 and the downstream sealing door 280 are slidable similar to the upstream sealing door 135a and the downstream sealing door 135b and may be positioned over one of the inlet openings 113 to form a sealed enclosure therebetween having the sorbent module 120 therein to perform desorption on the sorbent module 120 via the porous upstream heater 255 and the porous downstream heater 265. For inlet openings 113 without the upstream and downstream sealing doors 270, 280, the flow generators 140 may induce flow of fluid therethrough and, due to the porous upstream heater 255 and the porous downstream heater 265 being porous, the fluid is able to flow through the porous upstream heater 255, the sorbent modules 120, and the porous downstream heater 265 such that the sorbent modules 120 perform adsorption on the fluid flowing therethrough.

Set forth below are some embodiments of the foregoing disclosure:
Embodiment 1: An adsorption and desorption assembly including a housing defining a plenum space therein, an inlet assembly, including an inlet frame comprising a first inlet opening and a second inlet opening, the first inlet opening and the second inlet opening being fluidly connected to the plenum space, a first sorbent module disposed within the first inlet opening and a second sorbent module disposed within the second inlet opening, the first sorbent module configured to adsorb gas(es), vapor(s), or a mixture thereof from fluid passing through the first inlet opening, and the second sorbent module configured to adsorb the gas(es), the vapor(s), or the mixture thereof from fluid passing through the second inlet opening, and a desorption structure movable between the first inlet opening and the second inlet opening, and one or more flow generators fluidly connected to the plenum space and configured to remove, from the plenum space, fluid with the gas(es), the vapor(s), or the mixture thereof adsorbed therefrom by the first sorbent module or the second sorbent module, wherein the desorption structure is configured to form a sealed enclosure around the first sorbent module and desorb the gas(es), the vapor(s), or the mixture thereof from the first sorbent module when the desorption structure is positioned at the first inlet opening, and the desorption structure is configured to form the sealed enclosure around the second sorbent module and desorb the gas(es), the vapor(s), or the mixture thereof from the second sorbent module when the desorption structure is positioned at the second inlet opening.
Embodiment 2: The adsorption and desorption assembly as in any prior embodiment, wherein the sealed enclosure is fluidly isolated from the plenum space.
Embodiment 3: The adsorption and desorption assembly as in any prior embodiment, wherein the plenum space is an undivided space.
Embodiment 4: The adsorption and desorption assembly as in any prior embodiment, wherein the desorption structure comprises an upstream sealing door on an upstream side of the inlet frame and a downstream sealing door on a downstream side of the inlet frame.
Embodiment 5: The adsorption and desorption assembly as in any prior embodiment, wherein the upstream sealing door and the downstream sealing door comprise sealing structures configured to form seals against the inlet frame around the first inlet opening when the desorption structure is positioned at the first inlet opening and form seals against the inlet frame around the second inlet opening when the desorption structure is positioned at the second inlet opening.
Embodiment 6: The adsorption and desorption assembly as in any prior embodiment, wherein the upstream sealing door or the downstream sealing door comprises a heater configured to heat the first sorbent module when the desorption structure is positioned at the first inlet opening and heat the second sorbent module when the desorption structure is positioned at the first inlet opening.
Embodiment 7: The adsorption and desorption assembly as in any prior embodiment, wherein each of the upstream sealing door and the downstream sealing door comprises a heater configured to heat the first sorbent module when the desorption structure is positioned at the first inlet opening and heat the second sorbent module when the desorption structure is positioned at the second inlet opening.
Embodiment 8: The adsorption and desorption assembly as in any prior embodiment, wherein the upstream sealing door comprises a first dielectric plate and the downstream sealing door comprises a second dielectric plate, and electromagnetic fields are alternated between the first dielectric plate and the second dielectric plate to heat the first sorbent module when the desorption structure is positioned at the first inlet opening and heat the second sorbent module when the desorption structure is positioned at the second inlet opening.
Embodiment 9: The adsorption and desorption assembly as in any prior embodiment, wherein the inlet frame comprises an upstream rail and a downstream rail, the upstream sealing door comprises upstream rail tabs that engage with the upstream rail such that the upstream sealing door is movable along the upstream rail, and the downstream sealing door comprises downstream rail tabs that engage with the downstream rail such that the downstream sealing door is movable along the downstream rail.
Embodiment 10: The adsorption and desorption assembly as in any prior embodiment, wherein the desorption structure is configured to form a sealed enclosure around the first sorbent module when the desorption structure is positioned at the first inlet opening and around the second sorbent module when the desorption structure is positioned at the second inlet opening.
Embodiment 11: The adsorption and desorption assembly as in any prior embodiment, wherein the desorption structure is configured to block fluid from passing through the first sorbent module and allow fluid to pass through the second sorbent module when the desorption structure is positioned at the first inlet opening, and block fluid from passing through the second sorbent module and allow fluid to pass through the first sorbent module when the desorption structure is positioned at the second inlet opening.
Embodiment 12: The adsorption and desorption assembly as in any prior embodiment, further comprising an outlet fluidly coupled to the sealed enclosure to remove the gas(es), the vapor(s), or the mixture thereof from the sealed enclosure.
Embodiment 13: The adsorption and desorption assembly as in any prior embodiment, wherein further comprising actuators configured to move the upstream sealing door and the downstream sealing door toward and away from the first inlet opening and the second inlet opening.
Embodiment 14: The adsorption and desorption assembly as in any prior embodiment, wherein the heater is an inductive heater.
Embodiment 15: The adsorption and desorption assembly as in any prior embodiment, further comprising a preliminary heater disposed upstream of the inlet frame and movable between the first inlet opening and the second inlet opening to dry the fluid passing therethrough.
Embodiment 16: The adsorption and desorption assembly as in any prior embodiment, wherein the plenum space is divided into a first plenum space and a second plenum space that are fluidly isolated from each other, and the one or more flow generators comprises a first flow generator fluidly connected to the first plenum space and configured to remove, from the first plenum space, fluid with the gas(es), the vapor(s), or the mixture thereof adsorbed therefrom by the first sorbent module, and the one or more flow generators comprises a second flow generator fluidly connected to the second plenum space and configured to remove, from the second plenum space, fluid with the gas(es), the vapor(s), or the mixture thereof adsorbed therefrom by the second sorbent module.
Embodiment 17: The adsorption and desorption assembly as in any prior embodiment, wherein the adsorption and desorption assembly is configured to receive and adsorb gas(es), vapor(s), or a mixture thereof from fluid from an area directly surrounding the adsorption and desorption assembly.
Embodiment 18: A method including generating a first flow of fluid through a first sorbent module disposed at a first inlet opening of an adsorption and desorption assembly into a plenum space within the adsorption and desorption assembly to adsorb gas(es), vapor(s), or a mixture thereof from the first flow of fluid, positioning a desorption structure at a second inlet opening of the adsorption and desorption assembly, forming a sealed enclosure around a second sorbent module disposed at a second inlet opening of the adsorption and desorption assembly via a desorption structure and desorbing the gas(es), the vapor(s), or the mixture thereof from the second sorbent module, moving the desorption structure from the second inlet opening to the first inlet opening of the adsorption and desorption assembly, generating a second flow of fluid through the second sorbent module disposed at the second inlet opening into the plenum space to adsorb the gas(es), the vapor(s), or the mixture thereof from the second flow of fluid, and forming the sealed enclosure around the first sorbent module via the desorption structure and desorbing the gas(es), the vapor(s), or the mixture thereof from the second first module, wherein the generating the first flow of fluid through the first sorbent module and the desorbing the gas(es), the vapor(s), or the mixture thereof from the second sorbent module are performed simultaneously, and the generating the second flow of fluid through the second sorbent module and the desorbing the gas(es), the vapor(s), or the mixture thereof from the first sorbent module are performed simultaneously.
Embodiment 19: An adsorption and desorption assembly including a housing defining a plenum space therein, an inlet assembly, including an inlet frame comprising a first inlet opening and a second inlet opening, the first inlet opening and the second inlet opening being fluidly connected to the plenum space, a first sorbent module disposed within the first inlet opening and a second sorbent module disposed within the second inlet opening, the first sorbent module configured to adsorb gas(es), vapor(s), or a mixture thereof from fluid passing through the first inlet opening, and the second sorbent module configured to adsorb the gas(es), the vapor(s), or the mixture thereof from fluid passing through the second inlet opening, and one or more sealing structures, one or more desorption structures, and one or more flow generators fluidly connected to the plenum space and configured to remove, from the plenum space, fluid with the gas(es), the vapor(s), or the mixture thereof adsorbed therefrom by the first sorbent module or the second sorbent module, wherein the one or more sealing structures is configured to form a sealed enclosure around the first sorbent module and the one or more desorption structures is configured to desorb the gas(es), the vapor(s), or the mixture thereof from the first sorbent module within the sealed enclosure, and the one or more sealing structures is configured to form the sealed enclosure around the second sorbent module and desorb the gas(es), the vapor(s), or the mixture thereof from the second sorbent module within the sealed enclosure.
Embodiment 20: The adsorption and desorption assembly as in any prior embodiment, wherein the one or more desorption structure comprises a first porous heater disposed in the first inlet opening and a second porous heater disposed in the second inlet opening, the first porous heater and the second porous heater being configured to allow the gas(es), the vapor(s), or the mixture thereof to pass therethrough.

The use of the terms “a” and “an” and “the” and similar referents in the context of describing the invention (especially in the context of the following claims) are to be construed to cover both the singular and the plural, unless otherwise indicated herein or clearly contradicted by context. Further, it should be noted that the terms “first,” “second,” and the like herein do not denote any order, quantity, or importance, but rather are used to distinguish one element from another. The terms “about”, “substantially” and “generally” are intended to include the degree of error associated with measurement of the particular quantity based upon the equipment available at the time of filing the application. For example, “about” and/or “substantially” and/or “generally” can include a range of ±8% of a given value.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited.

What is claimed is:

1. An adsorption and desorption assembly comprising:
a housing defining a plenum space therein;
an inlet assembly, comprising:
an inlet frame comprising a first inlet opening and a second inlet opening, the first inlet opening and the second inlet opening being fluidly connected to the plenum space,
a first sorbent module disposed within the first inlet opening and a second sorbent module disposed within the second inlet opening, the first sorbent module configured to adsorb gas(es), vapor(s), or a mixture thereof from fluid passing through the first inlet opening, and the second sorbent module configured to adsorb the gas(es), the vapor(s), or the mixture thereof from fluid passing through the second inlet opening; and
a desorption structure movable between the first inlet opening and the second inlet opening; and
one or more flow generators fluidly connected to the plenum space and configured to remove, from the plenum space, fluid with the gas(es), the vapor(s), or the mixture thereof adsorbed therefrom by the first sorbent module or the second sorbent module,
wherein the desorption structure is configured to form a sealed enclosure around the first sorbent module and desorb the gas(es), the vapor(s), or the mixture thereof from the first sorbent module when the desorption structure is positioned at the first inlet opening, and the desorption structure is configured to form the sealed enclosure around the second sorbent module and desorb the gas(es), the vapor(s), or the mixture thereof from the second sorbent module when the desorption structure is positioned at the second inlet opening.

2. The adsorption and desorption assembly of claim 1, wherein the sealed enclosure is fluidly isolated from the plenum space.

3. The adsorption and desorption assembly of claim 1, wherein the plenum space is an undivided space.

4. The adsorption and desorption assembly of claim 1, wherein the desorption structure comprises an upstream sealing door on an upstream side of the inlet frame and a downstream sealing door on a downstream side of the inlet frame.

5. The adsorption and desorption assembly of claim 4, wherein the upstream sealing door and the downstream sealing door comprise sealing structures configured to form seals against the inlet frame around the first inlet opening when the desorption structure is positioned at the first inlet opening and form seals against the inlet frame around the second inlet opening when the desorption structure is positioned at the second inlet opening.

6. The adsorption and desorption assembly of claim 4, wherein the upstream sealing door or the downstream sealing door comprises a heater configured to heat the first sorbent module when the desorption structure is positioned at the first inlet opening and heat the second sorbent module when the desorption structure is positioned at the first inlet opening.

7. The adsorption and desorption assembly of claim 4, wherein each of the upstream sealing door and the downstream sealing door comprises a heater configured to heat the first sorbent module when the desorption structure is positioned at the first inlet opening and heat the second sorbent module when the desorption structure is positioned at the second inlet opening.

8. The adsorption and desorption assembly of claim 4, wherein the upstream sealing door comprises a first dielectric plate and the downstream sealing door comprises a second dielectric plate, and electromagnetic fields are alternated between the first dielectric plate and the second dielectric plate to heat the first sorbent module when the desorption structure is positioned at the first inlet opening and heat the second sorbent module when the desorption structure is positioned at the second inlet opening.

9. The adsorption and desorption assembly of claim 4, wherein the inlet frame comprises an upstream rail and a downstream rail, the upstream sealing door comprises upstream rail tabs that engage with the upstream rail such that the upstream sealing door is movable along the upstream rail, and the downstream sealing door comprises downstream rail tabs that engage with the downstream rail such that the downstream sealing door is movable along the downstream rail.

10. The adsorption and desorption assembly of claim 1, wherein the desorption structure is configured to form a sealed enclosure around the first sorbent module when the desorption structure is positioned at the first inlet opening and around the second sorbent module when the desorption structure is positioned at the second inlet opening.

11. The adsorption and desorption assembly of claim 1, wherein the desorption structure is configured to block fluid from passing through the first sorbent module and allow fluid to pass through the second sorbent module when the desorption structure is positioned at the first inlet opening, and block fluid from passing through the second sorbent module and allow fluid to pass through the first sorbent module when the desorption structure is positioned at the second inlet opening.

12. The adsorption and desorption assembly of claim 1, further comprising an outlet fluidly coupled to the sealed enclosure to remove the gas(es), the vapor(s), or the mixture thereof from the sealed enclosure.

13. The adsorption and desorption assembly of claim 5, wherein further comprising actuators configured to move the upstream sealing door and the downstream sealing door toward and away from the first inlet opening and the second inlet opening.

14. The adsorption and desorption assembly of claim 6, wherein the heater is an inductive heater.

15. The adsorption and desorption assembly of claim 1, further comprising a preliminary heater disposed upstream of the inlet frame and movable between the first inlet opening and the second inlet opening to dry the fluid passing therethrough.

16. The adsorption and desorption assembly of claim 1, wherein the plenum space is divided into a first plenum space and a second plenum space that are fluidly isolated from each other, and the one or more flow generators comprises a first flow generator fluidly connected to the first plenum space and configured to remove, from the first plenum space, fluid with the gas(es), the vapor(s), or the mixture thereof adsorbed therefrom by the first sorbent module, and the one or more flow generators comprises a second flow generator fluidly connected to the second plenum space and configured to remove, from the second plenum space, fluid with the gas(es), the vapor(s), or the mixture thereof adsorbed therefrom by the second sorbent module.

17. The adsorption and desorption assembly of claim 1, wherein the adsorption and desorption assembly is configured to receive and adsorb gas(es), vapor(s), or a mixture thereof from fluid from an area directly surrounding the adsorption and desorption assembly.

18. A method comprising:
generating a first flow of fluid through a first sorbent module disposed at a first inlet opening of an adsorption and desorption assembly into a plenum space within the adsorption and desorption assembly to adsorb gas(es), vapor(s), or a mixture thereof from the first flow of fluid;
positioning a desorption structure at a second inlet opening of the adsorption and desorption assembly;
forming a sealed enclosure around a second sorbent module disposed at a second inlet opening of the adsorption and desorption assembly via a desorption structure and desorbing the gas(es), the vapor(s), or the mixture thereof from the second sorbent module;
moving the desorption structure from the second inlet opening to the first inlet opening of the adsorption and desorption assembly;
generating a second flow of fluid through the second sorbent module disposed at the second inlet opening into the plenum space to adsorb the gas(es), the vapor(s), or the mixture thereof from the second flow of fluid; and
forming the sealed enclosure around the first sorbent module via the desorption structure and desorbing the gas(es), the vapor(s), or the mixture thereof from the second first module,
wherein the generating the first flow of fluid through the first sorbent module and the desorbing the gas(es), the vapor(s), or the mixture thereof from the second sorbent module are performed simultaneously, and the generating the second flow of fluid through the second sorbent module and the desorbing the gas(es), the vapor(s), or the mixture thereof from the first sorbent module are performed simultaneously.

19. An adsorption and desorption assembly comprising:
a housing defining a plenum space therein;
an inlet assembly, comprising:
an inlet frame comprising a first inlet opening and a second inlet opening, the first inlet opening and the second inlet opening being fluidly connected to the plenum space,
a first sorbent module disposed within the first inlet opening and a second sorbent module disposed within the second inlet opening, the first sorbent module configured to adsorb gas(es), vapor(s), or a mixture thereof from fluid passing through the first inlet opening, and the second sorbent module configured to adsorb the gas(es), the vapor(s), or the mixture thereof from fluid passing through the second inlet opening, and
one or more sealing structures;
one or more desorption structures; and
one or more flow generators fluidly connected to the plenum space and configured to remove, from the plenum space, fluid with the gas(es), the vapor(s), or the mixture thereof adsorbed therefrom by the first sorbent module or the second sorbent module,
wherein the one or more sealing structures is configured to form a sealed enclosure around the first sorbent module and the one or more desorption structures is configured to desorb the gas(es), the vapor(s), or the mixture thereof from the first sorbent module within the sealed enclosure, and the one or more sealing structures is configured to form the sealed enclosure around the second sorbent module and desorb the gas(es), the vapor(s), or the mixture thereof from the second sorbent module within the sealed enclosure.

20. The adsorption and desorption assembly of claim 19, wherein the one or more desorption structure comprises a first porous heater disposed in the first inlet opening and a second porous heater disposed in the second inlet opening, the first porous heater and the second porous heater being configured to allow the gas(es), the vapor(s), or the mixture thereof to pass therethrough.
